(19) United States
(12) Patent Application Publication
(10) Pub. No.: US 2006/0167785 A1
(43) Pub. Date: Jul. 27, 2006

(54) Bidding a price for goods and/or services in an auction of wireless communication access requests within a marketplace

(76) Inventors: Francis Joseph Mullany, Blackrock (IE); Lester Tse Wee Ho, Swindon (GB); Holger Claussen, Swindon (GB); Louis Gwyn Samuel, Swindon (GB)

Correspondence Address: WILLIAMS, MORGAN & AMERSON, 10333 RICHMOND, SUITE 1100, HOUSTON, TX, 77042, US

(21) Appl. No.: 11/045,011

(22) Filed: Jan. 27, 2005

(51) Int. Cl. G06Q 40/00

(52) U.S. Cl. 705/37

(57) ABSTRACT

The present invention provides a method and an apparatus for using a bidding strategy to select a bid price for at least one of goods and services in an auction of wireless communication access requests within a marketplace of sellers and buyers to obtain a profit gain in that auction. A communications system may include a broker to select a bid price in response to a service request from a mobile communication device to an operator including a bidding algorithm for bidding a price in an auction. At an operator, a bidding algorithm, in accordance with one embodiment, may provide or use a robust, adaptive bidding strategy that may maximize the profit gain in a bidding process by assuming one of at least two forms for a probability of winning as a function of a bid price and through the use of a set of mixed strategies. The bidding strategy may identify a form, for the probability of winning, that may be currently prevalent and determine one or more parameter values defining a probability function based on the identified form. Using a state machine for a bidder's strategy, the bidding algorithm may provide a trade-off between optimizing the revenue and investigating the current conditions in the marketplace.

### BACKGROUND OF THE INVENTION

1. Field of the Invention

This invention relates generally to telecommunications, and more particularly, to wireless communications.

2. Description of the Related Art

As wireless access technologies evolve, there is an apparent increase in the number and complexity of options for the provision of wireless access, e.g., a multiplicity of network providers with various air interface technologies may compete to provide that wireless access. Under such conditions, one method for efficient resource allocation and maximization of end-user access to those resources is to construct an agent-based market for transport for calls and data sessions that operates on a per-call/per-session basis. In other words, software agents acting on behalf of the network operators competitively bid to provide network transport for individual calls and data sessions. Because of such autonomous behavior and intractable implications, e.g., on per-session and/or call trading bidding strategies of wireless access providers; it may be difficult to quantitatively assess the economic outcomes of bidding in various multi-operator competitive scenarios.

FIG. 2 shows a marketplace 200 comprising a plurality of sellers or suppliers 205(1-M) and a plurality of buyers 215(1-N) with no direct leakage of information between the plurality of sellers or suppliers 205(1-M). For example, the marketplace 200 may refer to a central resource for connecting the buyers 215(1-N) with the sellers 205(1-M) when bidding for goods and/or services to users, such as users of wireless communication devices a communications system that wish to obtain a service over a distributed, flexible wireless access network.

In particular, a general instantiation of bidding for goods and/or services is illustrated in an open marketplace 210 where (a) a number (N≧1) of buyers multiplicity among the plurality of buyers 215(1-N) may be free to order goods and/or services from a number (M≧1) of sellers, (b) a significant number of requests may be arriving over a non-zero-length period of time, and (c) only limited information may reach a seller 205, i, regarding the activities of another seller 205, j≠ i. An example of the marketplace 200 where the last condition (c) holds is in a single-shot closed (or “sealed-bid”) auction in which each interested seller 205 submits a sealed or closed bid price to a given buyer 215 (or a broker running the auction) for a service or good that the buyer 215 requests. The buyer 215 then informs the seller 205 of a successful bidding by its acceptance of the bid price. Other sellers 205 may not be informed of the winning bid or even of the winning bid price. Examples of such markets may include a marketplace scenario for per-session/call trading where the buyers 215(1-N) are end-users of telecommunication services and the sellers 205 (1-M) are network operators and/or service providers.

When multiple sellers may be bidding prices to offer the same goods and/or services to different buyers without knowing results of winning bids, another assumption made for the open marketplace 210 that involves complexities regarding a market state may render some solutions, such as outlined below ineffective. However, in some markets, the roles, at a top level, may be reversed, i.e. a number of buyers may be competing with bid prices to purchase a given service or network transport. A marketplace scenario where the roles could be reversed, i.e. a number of buyers may supply bids to a given seller, rather than the other way around, may include the buyers 215(1-N) as wireless telecom providers, such as Mobile Virtual Network Providers (MVNOs) and the sellers 205 (1-M) as spectrum owners.

Regardless of a specific type of a marketplace, however, it is difficult to determine an ideal strategy for a bidding entity to use when selecting a bid price because different approaches may be used by other bidders in the marketplace 200, sometimes successfully, depending on particular circumstances. For example, in a competitive market since the level of competition between bidders is high, a given bidder does not have a big enough presence in the marketplace 200 to change the probability of a successful bid pₛ(b) for a given bid price b as described by Hal R. Varian, in Intermediate Microeconomics—A Modern Approach, 6th ed., W. W. Norton & Company, New York, USA, 2003.

More specifically, FIG. 4A shows a general form of a probability of winning pₛ with a successful bid as a function of a bid price b. A shape of the function pₛ (b) is shown in FIG. 4A with pₛ(b)=1 for b low enough, pₛ(b)=0 for b high enough and monotonically decreasing between these two domains. One problem then reverts to one of the bidding seller to select b such that the net profit or surplus is maximized, i.e. select b=bₒₚₜ where:
bₒₚₜ=arg max{[b−c_{win}(b)]pₛ(b)} (1)
and c_{win}(b) is the cost of supplying the service, excluding those costs that would have been incurred even if the seller loses (e.g., auction participation costs, fixed costs, etc.).

In another example, arising under different market conditions, FIG. 4B shows a general form of a probability of winning with a successful bid as a function of a bid price b for the Bertrand model where the price b_{T} is the supply cost of the lowest competitor. The Bertrand model is a particular type of game where the conditions may not be changing and fairly simple—(i) the cost base of the sellers doesn't change, (ii) the buyers' demand remains inelastic, and (iii) all sellers can meet the demand. Based on the probability of winning, as given in FIG. 4B, one relatively simple solution uses the Nash equilibrium where the seller with the lowest cost base selects a price that is just lower than the cost base of its competitors, as disclosed by C. Courcoubetis and R. Weber, in Pricing Communication Networks, Wiley, Chichester, UK, 2001.

A number of problems exist with the approaches set forth above for the two examples. While FIG. 4A is consistent with a competitive scenario, FIG. 4B is consistent with a Bertrand model. First, for the competitive market scenario, often there are a low number of competitors, so the marketplace 200 is not completely competitive, i.e. the sellers 205 are not just “price takers”—their bids influence the market outcomes, as known as an oligopoly. Secondly, even in competitive markets, the conditions change, e.g., supply becomes limited for some sellers, sellers' cost bases vary, participation in the market of sellers and or buyers changes, etc. As a result, determining pₛ(b) accordingly becomes an issue. Finally, the Bertrand model demands a very simple scenario where the participation also remains constant and the costs of supplying a service are the same for all buyers. When the shape of pₛ(b) changes from that given in FIG. 4B, for whatever reason, then the classical solution to the Bertrand model is no longer optimal. Examples for such deviations from FIG. 4B include suppliers running out of resources to support the given services and the aggregate user demand being elastic so that if prices rise too high some users refuse to accept even the lowest bid.

The present invention is directed to overcoming, or at least reducing, the effects of, one or more of the problems set forth above.

### SUMMARY OF THE INVENTION

In one embodiment of the present invention, a method is provided for bidding a price in an auction for at least one of goods and services within a marketplace. The method comprises defining a probability of winning as a function of a bid price in response to a request for wireless access in a user communication, formulating the bidding strategy in the auction based on one of at least two forms of the probability of winning, identifying a form for the probability of winning, and determining one or more parameter values for the probability of winning based on the identified form to obtain a profit gain in the auction.

In another embodiment, an operator associated with a wireless communication access network, to bid for at least one of goods and services in a marketplace, comprises a controller and a storage coupled to the controller. The storage may store instructions for bidding a price in an auction for at least one of goods and services within a marketplace to define a probability of winning as a function of a bid price in response to a request for wireless access in a user communication, formulate the bidding strategy in the auction based on one of at least two forms of the probability of winning, identify a form for the probability of winning, and determine one or more parameter values for the probability of winning based on the identified form to obtain a profit gain in the auction.

In yet another embodiment, a communications system comprises an operator associated with a wireless communication access network to bid for at least one of goods and services in a marketplace. The operator includes a controller and a storage coupled to the controller. The storage may store instructions for bidding a price in an auction for at least one of goods and services within a marketplace to define a probability of winning as a function of a bid price in response to a request for wireless access in a user communication, formulate the bidding strategy in the auction based on one of at least two forms of the probability of winning, identify a form for the probability of winning, and determine one or more parameter values for the probability of winning based on the identified form to obtain a profit gain in the auction.

In still another embodiment, an article comprising a computer readable storage medium storing instructions that, when executed cause a communications system to bid a price in an auction for at least one of goods and services within a marketplace. The communications system to define a probability of winning as a function of a bid price in response to a request for wireless access in a user communication, formulate the bidding strategy in the auction based on one of at least two forms of the probability of winning, identify a form for the probability of winning, and determine one or more parameter values for the probability of winning based on the identified form to obtain a profit gain in the auction.

In a further embodiment, an apparatus for bidding a price in an auction for at least one of goods and services within a marketplace comprises means for defining a probability of winning as a function of a bid price in response to a request for wireless access in a user communication. The apparatus further comprises means for formulating the bidding strategy in the auction based on one of at least two forms of the probability of winning, means for identifying a form for the probability of winning, and means for determining one or more parameter values for the probability of winning based on the identified form to obtain a profit gain in the auction.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a communications system including a broker to select a bid price in response to a service request from a mobile communication device of a plurality of mobile communication devices to an operator of a multiplicity of operators each including a bidding algorithm for bidding a price in an auction for at least one of goods and services within a marketplace to obtain a profit gain in the auction according to one illustrative embodiment of the present invention;

FIG. 2 shows a conventional marketplace comprising a plurality of sellers or suppliers and a plurality of buyers with no direct leakage of information between the plurality of sellers;

FIG. 3 illustrates a stylized representation of a flow chart implementing a method for using a bidding strategy to select a bid price for at least one of goods and services in an auction of wireless communication access requests within a marketplace, for example, when rendering a wireless service to a user consistent with one embodiment of the present invention;

FIG. 4A schematically shows a conventional form of a probability of winning with a successful bid as a function of a bid price b where a shape of a function pₛ(b) is shown with pₛ(b)=1 for b low enough, pₛ(b)=0 for b high enough and the shape decreases monotonically between these two domains;

FIG. 4B schematically shows a conventional form of a probability of winning with a successful bid as a function of a bid price b consistent with a Bertrand model where the price b_{T} is the supply cost of the lowest competitor;

FIG. 5A schematically depicts an assumed model S for modeling a semi-static function, based on a step function form for a probability of winning with a bid value of b, of a successful bid being function of the bid price in accordance with one illustrative embodiment of the present invention;

FIG. 5B schematically depicts another assumed model T for modeling a semi-static function, based on a quasi-linear function form to characterize the probability of winning with a bid value of b, of a successful bid being function of the bid price according to an exemplary embodiment of the present invention;

FIG. 6 illustrates a stylized representation of a state machine that implements the bidding strategy shown in FIG. 3 to select a bid price for at least one of goods and services in an auction of wireless communication access requests within a marketplace consistent with one embodiment of the present invention; and

FIG. 7 schematically depicts an alternate to the assumed model T shown in FIG. 5B to approximate the probability of winning with a successful bid as a function of the bid price consistent with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a communications system may include a broker to select a bid price in response to a service request from a mobile communication device to an operator including a bidding algorithm for bidding a price in an auction for at least one of goods and services within a marketplace to obtain a profit gain in that auction. At an operator, a bidding algorithm, in accordance with one embodiment, may provide or use a robust, adaptive bidding strategy that may maximize the profit gain in a bidding process by assuming one of at least two forms for a probability of winning as a function of a bid price and through the use of a set of mixed strategies. The bidding strategy may identify a form, for the probability of winning, that may be currently prevalent and determine one or more parameter values defining a probability function based on the identified form. Using a state machine for a bidder's strategy, the bidding algorithm may provide a trade-off between optimizing the revenue and investigating the current conditions in the marketplace. The state machine may offer a relatively simple approach to a bidding process that may be less likely to cause a catastrophic error. That is, in one embodiment, the bidding strategy may be robust and adaptive to changes in one or more market conditions of the marketplace.

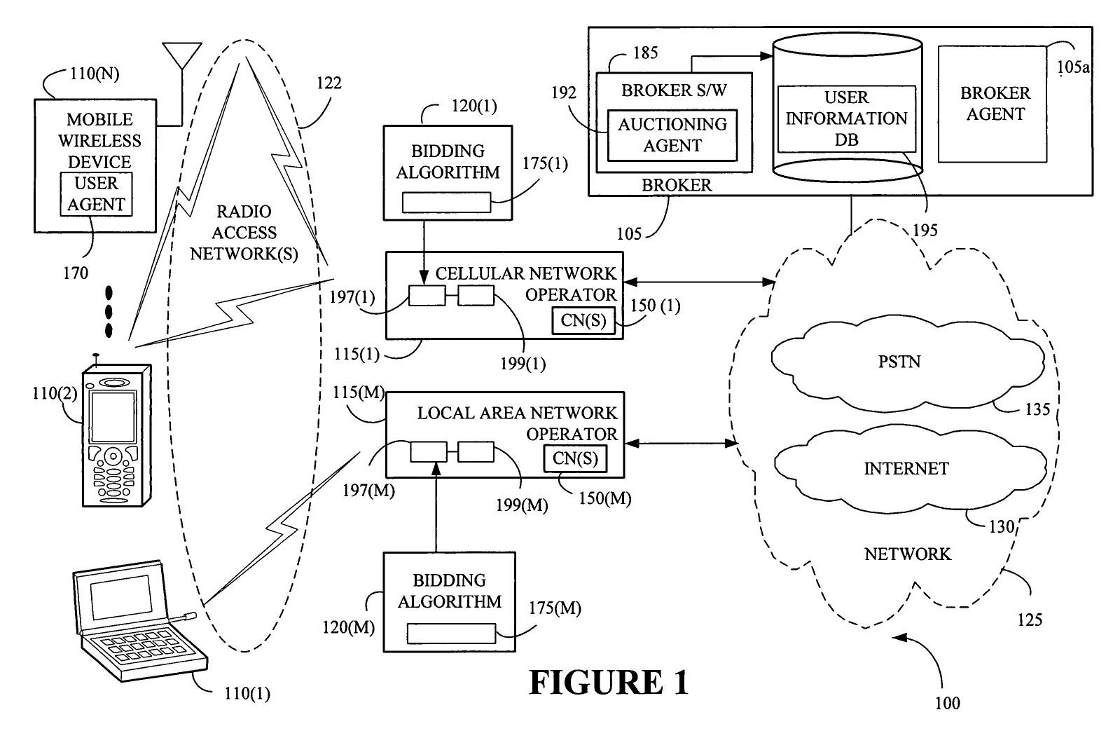

Referring to FIG. 1, a communications system 100 includes a broker 105 to select a bid price in an auction for at least one of goods and services within a marketplace to obtain a profit gain in the auction according to one illustrative embodiment of the present invention. In response to a service request, from a particular mobile wireless device 110(N) of a plurality of mobile communication devices 110(1-N) to an operator 115(M) of a multiplicity of operators 115(1-M), each including a bidding algorithm 120 for bidding a price, the broker 105 may exchange data between one or more mobile communication devices of the plurality of mobile wireless devices 110(1-N) and one or more operators of the multiplicity of operators 115(1-M) involved in a bidding process, for example, to render a wireless service to a user.

Examples of the communications system 100 of FIG. 1 include a Universal Mobile Telecommunication System (UMTS), although it should be understood that the present invention may be applicable to other systems that support data and/or voice communication. That is, it should be understood, however, that the configuration of the communications system 100 of FIG. 1 is exemplary in nature, and that fewer or additional components may be employed in other embodiments of the communications system 100 without departing from the spirit and scope of the instant invention. Likewise, the mobile wireless device 110 may take the form of any of a variety of devices, including cellular phones, personal digital assistants (PDAs), laptop computers, digital pagers, wireless cards, and any other device capable of accessing one or more radio access network(s) 122 coupled to a network 125, such as an Internet Protocol (IP) network comprising the Internet 130 and a public telephone system (PSTN) 135. Each operator 115 may comprise one or more conventional core network(s) 150. Generally, the core network(s) 150 operate as an interface to the radio access network(s) 122 and the network 125, performing a variety of functions and operations, such as user authentication.

The operators 115(1-M) may be the owners of the radio access network(s) 122 which may, for example, include a global system for mobile communications (GSM), a universal mobile telecommunications system (UMTS), a wide local area network (WLAN), and the like, The operators 115(1-M) may provide transport for data, voice, video or other services. Usually, the networks of different operators overlap a particular region or area, such that a user may connect to more than one network operator or service provider at a location.

In one embodiment, the mobile wireless device 110 may be defined at least in part by a UMTS protocol. In one embodiment, the operator 115 may be defined at least in part by a UMTS protocol. The wireless communications between the mobile wireless devices 110(1-N) and the operators 115(1-M) may be established according to any one or more of network and/or communication protocols including, but not limited to, a UMTS protocol, a Global System for Mobile communications (GSM) protocol, a Code Division Multiple Access (CDMA) protocol, and the like. Use of a particular protocol in the communications system 100 to communicate over a wireless communication medium is a matter of design choice and not necessarily material to the present invention. Thus, only relevant aspects of the communications system 100 that are material to the instant invention are described below.

According to one embodiment, using the radio access network(s) 122, the mobile wireless devices 110(1-N) may communicate with a base station and a wireless local area network (WLAN) distributed within an area, such as service coverage area, to be serviced by the operators 115(1-M) across an air interface. To provide the wireless service to a user, the base station may transmit and receive messages from the mobile wireless devices 110(1-N), e.g., laptop computers or cell phones, in a cell that may be divided into multiple sectors. Likewise, the WLAN may transmit and receive messages via a communicate node, such as an access point.

In one embodiment, the communications system 100 may use an agent-based network architecture, in which a bid price for a service request from a user is processed by a user agent 170, a network operator agent 175, a broker agent 105a that uses broker software (S/W) 185. The broker S/W 185 generally refers to a software entity that may exchange data between the mobile wireless devices 110(1-N) and the operators 115(1-M) for the broker 105. The broker S/W 185 may comprise an auctioning agent 192 to negotiate service contracts or agreements based on a user information database (DB) 195. Each operator 115 may comprise a controller 197 coupled to a storage 199 for storing the bidding algorithm 120.

In operation, a wired and a wireless device user and/or a mobile service subscriber may request a wide array of services including voice and data services over the radio access network(s) 122. Using the bidding algorithm 120, one or more operators 115(1-M) may communicate with one or more mobile wireless devices 110(1-N) to bid a price of a service to a user on the radio access network(s) 122 of the communications system 100. To this end, the broker 105 may assist the bidding process for determining a winning bid price for a request of a desired service, such as a call or data session and informing the user of the winning bid price.

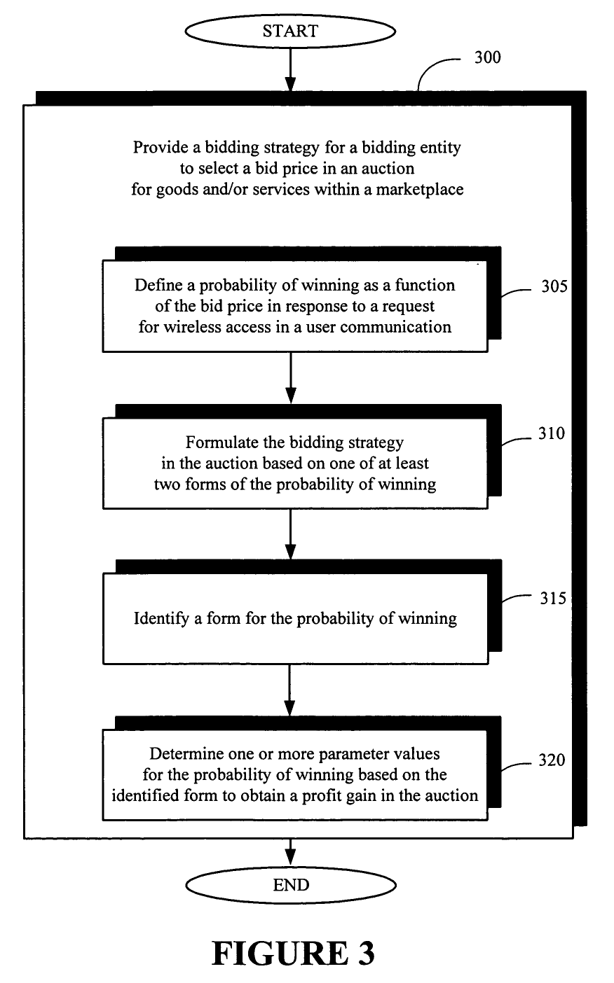

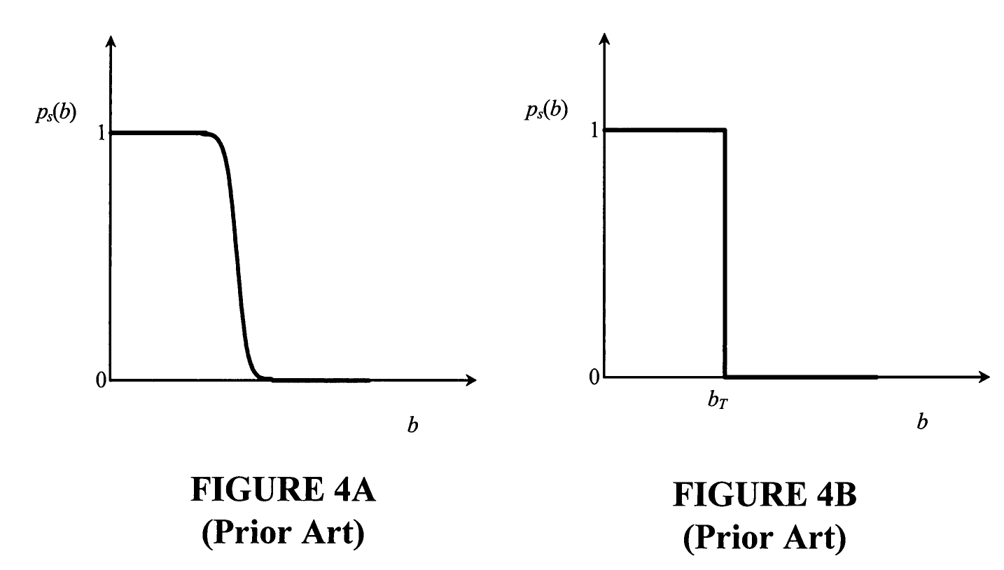

Turning now to FIG. 3, a stylized representation of a flow chart implementing a method for using a bidding strategy is illustrated to select a bid price for at least one of goods and services in an auction of wireless communication access requests within the marketplace 200, for example, when rendering a wireless service to a user consistent with one embodiment of the present invention. At each operator 115, the bidding algorithm 120, in accordance with one embodiment, may provide or use a robust, adaptive bidding strategy that may maximize the profit gain in the bidding process by assuming one of at least two forms for a probability of winning as a function of a bid price and through the use of a set of mixed strategies. The bidding strategy may identify a form, for the probability of winning, that may be currently prevalent and determine one or more parameter values defining a probability function based on the identified form.

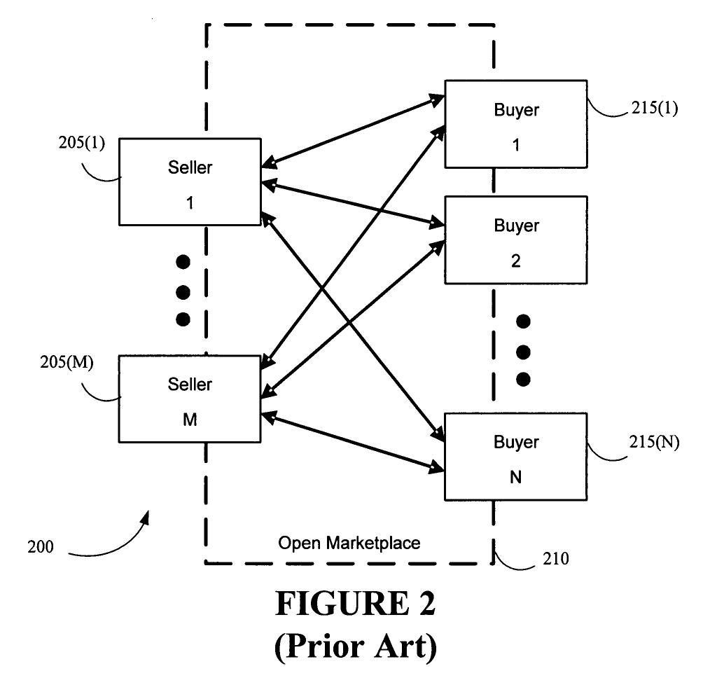

More specifically, at block 300, the bidding algorithm 120 may provide a bidding strategy for a bidding entity, such a buyer or a seller, for example, the operator 115(1) to select a bid price in an auction for goods and/or services within the marketplace 200 shown in FIG. 2. At block 305, a probability of winning may be defined as a function of the bid price in response to a request for wireless access in a user communication, i.e., from the mobile wireless device 110(N). Based on one of at least two forms of the probability of winning, the bidding algorithm 120 may formulate the bidding strategy in the auction, as indicated at block 310. A specific form, such the currently prevalent one may be identified for the probability of winning at block 315. Finally, in block 320, the bidding algorithm 120 may determine one or more parameter values for the probability of winning based on the identified form to obtain a maximum profit gain in that auction for the operator 115(1).

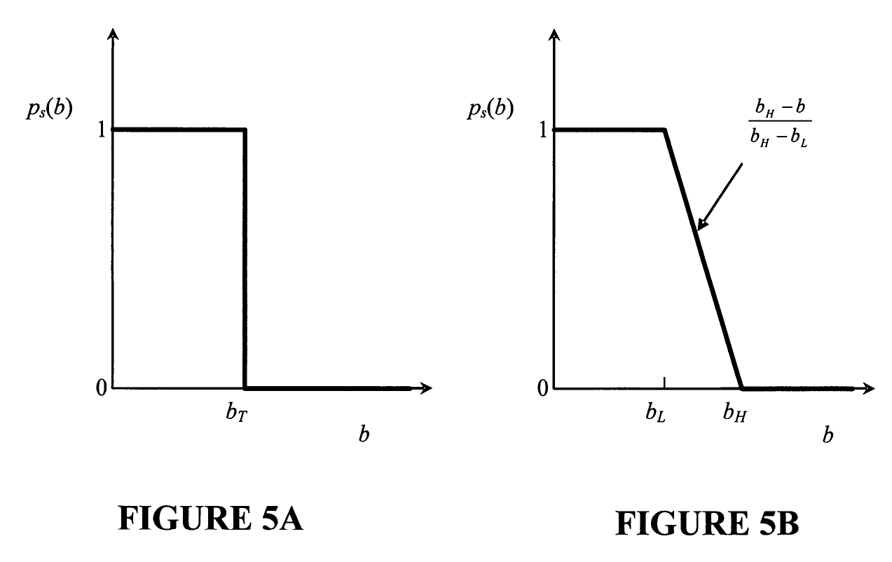

Referring to FIG. 5A, a first assumed model, S, is schematically depicted for modeling a semi-static function, based on a step function form in accordance with one illustrative embodiment of the present invention. For characterizing the probability of winning with a bid value of b, of a successful bid being function of the bid price, a seller's bidding strategy assumes that the probability of winning with a successful bid pₛ (b) is at least a semi-static function of the bid price and that that function pₛ(b) may be modeled using a step function form, as shown in the model S in FIG. 5A. When the seller, i.e., the operator 115(1) assumes that the model S describes the current situation, then the optimal behavior is that of a optimizing player in the Bertrand model, i.e. gradually increase the bid price from one bid to the next and when the seller first loses a bid, assume that a threshold b_{T} has been exceeded and the bid price may be reduced by one increment, i.e. below b_{T}.

Referring to FIG. 5B, a second assumed model, T, is schematically depicted for modeling a semi-static function, based on a quasi-linear function form according to an exemplary embodiment of the present invention. To characterize the probability of winning with a bid value of b, of a successful bid being function of the bid price, a seller's bidding strategy assumes that the probability of winning with a successful bid pₛ(b) is at least a semi-static function of the bid price and that that function pₛ(b) may be modeled using a general quasi-linear function form with at least two line segments for pₛ(b)=1 and pₛ(b)=0 respectively and a third linear segment between the two line segments, as shown in the model T in FIG. 5B. When the seller, i.e. the operator 115(1) assumes that the model T describes the current situation then a desired behavior is to use a mixed strategy to (a) maximize profit and (b) determine a shape of the curve of the semi-static function. A mixed strategy refers to bidding strategy where the bid price varies, even if conditions are known to remain identical.

To characterize this linear segment (and hence, the entire function pₛ(b)), the distribution of b may use two values, bₒ and bₒ+Δb, and let the probability of bidding bₒ be p₀. If the cost function c_{win}(b) is linear in b, i.e. c_{win}(b)=(1−η)b+k then the bidding algorithm 120 may select bₒ be p₀ so that

$$( {b}_{o} , {p}_{o} ) = arg {max}_{( {b}_{o} , {p}_{o} )} \{ E [ ( b - {c}_{win} ( b ) ) {p}_{s} ( b ) ] \} \\ = arg {max}_{( {b}_{o} , {p}_{o} )} \{ ( η {b}_{o} - k ) \frac{{b}_{H} - {b}_{o}}{{b}_{H} - {b}_{L}} {p}_{o} + ( η ( {b}_{o} + Δ b ) - k ) \\ \frac{{b}_{H} - {b}_{o} - Δ b}{{b}_{H} - {b}_{L}} ( 1 - {p}_{o} ) \} \qquad ( 2 )$$

The second line of the equation (2) ser forth above assumes that an optimal operating point lies on the linear segment between b_{L} and b_{H}. A solution may result in:

$${p}_{0} = \frac{1}{2} , \\ {b}_{0} = \frac{{b}_{H}}{2} + \frac{k}{2 η} - \frac{Δ b}{2} , \\ and {b}_{o} + Δ b = \frac{{b}_{H}}{2} + \frac{k}{2 η} + \frac{Δ b}{2} \qquad ( 3 )$$

The critical points b_{L} and b_{H} may be estimated from \hat{p}ⱼ(bₒ) and \hat{p}ⱼ(bₒ+Δb), the observed probabilities of bid success at b=bₒ and b=bₒ+Δb respectively. To achieve p₀=½, the seller may systematically alternate between bₒ and bₒ+Δb. A bidding seller, i.e. the operator 115(1) may be capable of switching between the first model S and the second model T set forth above in FIGS. 5A and 5B, respectively, adapting its behavior accordingly.

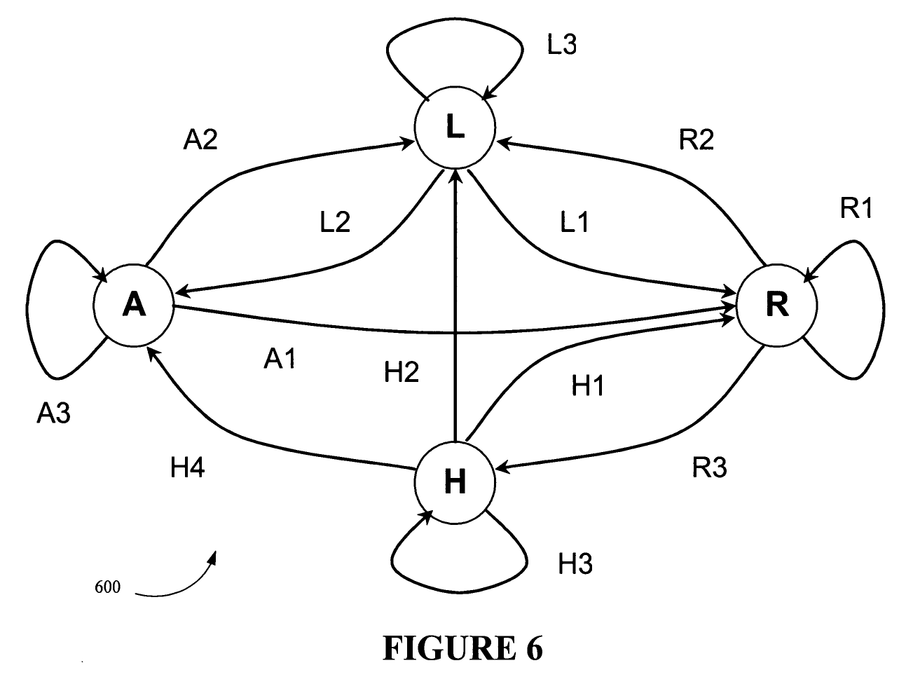

To this end, FIG. 6 illustrates a stylized representation of a state machine 600 that implements the bidding strategy consistent with one embodiment of the present invention, as shown in FIG. 3, to select a bid price for at least one of goods and services in an auction of wireless communication access requests within the marketplace 200. The state machine 600 may use at least two states, such as four states for the bidding strategy, in on embodiment. Namely, the four states include an advance state (A) indicating an increase in the bid level in increments, a retreat state (R) for reducing the bid level in increments, a linear state (L) to optimize the bid strategy according to the equation (2), and a hold state (H) to hold with the current bid value. While the states A, R, and H, with appropriate transition conditions, on their own may correspond to an assumption of model S shown in FIG. 5A, the states A, R, and L, with the appropriate transition conditions, on their own may correspond to an assumption of model T shown in FIG. 5B.

For the state machine 600, in one embodiment, the actions executed in each of the states before evaluating the transition conditions may be as follows:

A(dvance):
(i) Set b_{old}=bₒ.
(ii) Set bₒ=b_{old}+2Δb.
(iii) Partake in N auctions with bids alternating between b=bₒ and b=bₒ+Δb.
(iv) Measure the probabilities of success \hat{p}ₛ(bₒ) and \hat{p}ₛ(bₒ+Δb).

$$( v ) Set m = \frac{{\hat{p}}_{s} ( {b}_{o} + Δ b ) - {\hat{p}}_{s} ( {b}_{o} )}{Δ b} .$$

R(etreat):
(i) Set b_{old}=b.
(ii) Set bₒ=max{b_{old}−2Δb, k/η}.
(iii) As per (iii) to (v) inclusive for A.

H(old):
(i) No change to bₒ.
(ii) As per (iii) to (v) inclusive for A.

L(inear)

$$( i ) Set {b}_{L} = \frac{1 - {\hat{p}}_{s} ( {b}_{o} )}{m} + {b}_{o} . \\ ( ii ) Set {b}_{H} = \frac{- {\hat{p}}_{s} ( {b}_{o} + Δ b )}{m} + ( {b}_{o} + Δ b ) . \\ ( iii ) Set {b}_{o} = max \{ \frac{{b}_{H}}{2} + \frac{k}{2 η} - \frac{Δ b}{2} , \frac{k}{η} , {b}_{L} - Δ b \} .$$

(iv) As per (iii) to (v) inclusive for A.

One exemplary set of transition conditions in the state machine 600 is given below. This exemplary set of transition conditions involve (a) tests to determine if \hat{p}ₛ(bₒ) and/or m fall inside certain ranges and (b) (in state H only) checks on the value of a binary random variable q. The latter is to force the seller to check, by moving to the A state, whether or not conditions have changed (within the model S) so that a higher successful bid value is possible. One exemplary set of transition rules include following rules, but are not limited to the rules listed below:

A1 A→R if \hat{p}ₛ(bₒ)<pₜₕ(A→R)

A2 A→L if \hat{p}ₛ(bₒ)≧pₜₕ(A→R) and m<mₜₕ(A L)

A3 A→A if \hat{p}ₛ(bₒ)≧pₜₕ(A→R) and m≧mₜₕ(A→L)

L1 L→R if \hat{p}ₛ(bₒ)<pₜₕ(L→R)

L2 L→A if \hat{p}ₛ(bₒ)≧pₜₕ(L→R) and m<mₜₕ(L→A)

L3 L→L if \hat{p}ₛ(bₒ)≧pₜₕ(L→R) and m≧mₜₕ(L→A)

R1 R→R if \hat{p}ₛ(bₒ)<pₜₕ(R→R) or (m≧mₜₕ(R→L) and \hat{p}ₛ(bₒ)<pₜₕ(R→H))

R2 R→L if \hat{p}ₛ(bₒ)≧pₜₕ(R→R) and m<mₜₕ(R→L)

R3 R→H if \hat{p}ₛ(bₒ)≧pₜₕ(R→H) and m≧mₜₕ(R→L)

H1 H→R if \hat{p}ₛ(bₒ)<pₜₕ(H→R)

H2 H→L if \hat{p}ₛ(bₒ)≧pₜₕ(H→R) and m<mₜₕ(H→L)

H3 H→H if \hat{p}ₛ(bₒ)≧pₜₕ(H→R) and m≧mₜₕ(H→L) and q=1

H4 H→A if \hat{p}ₛ(bₒ)≧pₜₕ(H→R) and m≧mₜₕ(H→L) and q=0

The labeling in the state machine 600 corresponds with that shown in FIG. 6. That is, all pₜₕ(X→X) and mₜₕ(X→X) are threshold constants. The random variable qε{0,1} and q=1 are with probability P_{hold} and pₜₕ(R→H)≧pₜₕ(R→R).

Of course, in other embodiments, a different set of transition conditions may be contemplated without departing form the scope of the present invention since a particular group of transition conditions is merely a design choice of a person with an ordinary skill in the art. Therefore, a set of allowable transitions as shown in the state machine 600 in FIG. 6 may be varied. One or more actions in any given state may be varied as well. For example, while in states A and R, the bidding algorithm 120 may set Δb to zero to formulate a bidding strategy with no variation in bids between updates.

Another variation of the in-state actions involves changing a rate at which updates may occur (i.e. N may be changed above). For example, if there is a change in the bid value due to changes that a bidder has knowledge of in advance (e.g. changes in its supply) then relatively faster updates may be appropriate to gain temporary advantage over competitors. A change in an update rate may be based on a change, in at least one of a market condition or environment of the marketplace 200 and a technical condition or environment for the marketplace 200, of which a bidder has knowledge. By monitoring a bid value, for example, a change in the bid value may be detected based on a change of which a bidder has knowledge in advance. In response to the change in the bid value, the state machine 600 may cause the updates to occur relatively faster.

In some other embodiment, more than two models S and T may be used for the bidding strategy with a desired number and types of states in the state machine 600. A single model may be devised to cover all cases, for example, the model S is a pathological case of the model T. However, the bidding strategy of the bidding algorithm 120 may still result in a bidder behavior where the behavior moves between a number of different states, depending on a current set of conditions. When describing the model S as a sub-case of the model T, when the bidding algorithm 120 uses the sub-case model S the optimal bidding points will be less than b_{T}=b_{L}, whereas with the model T the optimal bidding points may be above or below b_{L}.

The bidding algorithm 120 may reverse the roles of the buyer and seller, i.e. a number of buyers put in bids for a good or a service to a given seller. The models S and T may change with low probability of success at low bids and high probability of success at high bids. The bidding strategy may be used with market structures in an auction other than a single-shot closed (sealed-bid) auction. For example, the bidding strategy be used with a simple offer-acceptance/rejection marketplace. Moreover, the bidding strategy may assume more complex models for pₛ(b), e.g. a model that may use a relatively complex function curves than the quasi-linear function used for the model T in FIG. 5B.

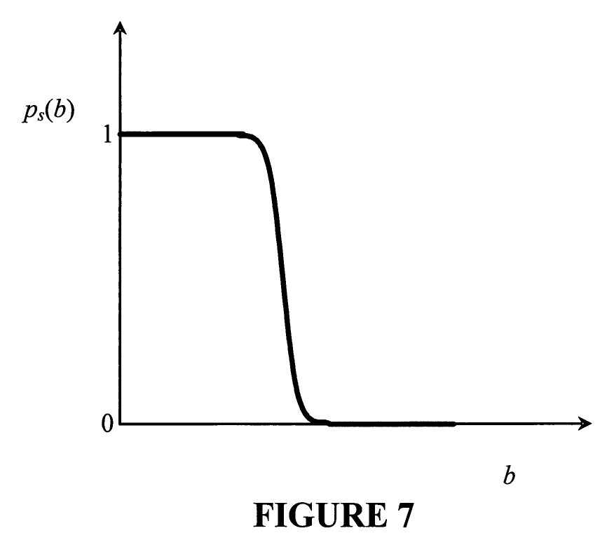

Accordingly, FIG. 7 schematically depicts an alternate to the assumed model T shown in FIG. 5B to approximate the probability of winning with a successful bid as a function of the bid price consistent with one embodiment of the present invention. In particular, the probability of winning with a successful bid as shown in FIG. 2 may be modeled more accurately using nonlinear functions as shown in FIG. 7. One option is a function, based on a Gaussian distribution:

$${p}_{s} ( b ) = {\int }_{b}^{∞} \frac{1}{σ \sqrt{2 π}} exp [ - \frac{1}{2} {( \frac{b - β}{σ} )}^{2} ] . \qquad ( 4 )$$

Another option entails using a tanh () function to approximate the probability function of a successful bid as:

$${p}_{s} ( b ) = - \frac{1}{2} tanh ( α ( b - β ) ) + \frac{1}{2} . \qquad ( 5 )$$

As in the case for the model T, shown in FIG. 5B, the use of a non-linear approximation for pₛ(b) involves at least two estimates and \hat{p}ⱼ(bₒ) and \hat{p}ⱼ(bₒΔb) in the region where pₛ(b)≠{0,1} to characterize the non-linear function. However, both the parameters of the non-linear approximation of the probability function and the solutions for the optimum bid value may be derived numerically.

In this manner, the bidding strategy implemented by the bidding algorithm 120, using a quasi-linear model T may characterize an actual probability of a successful bid as a function of bid price. To determine the one or more parameter values for the model T, the bidding algorithm 120 may use a mixed strategy with at least two bid prices b=bₒ and b=bₒ+Δb. A mixed strategy that occasionally perturbs the bid price upwards may ensure that a threshold b_{T} hasn't shifted in the model S of FIG. 5A. Moreover, a combination of the two models S and T may be used into a single state machine, i.e., the state machine 600 shown in FIG. 6. Finally, a non-linear model N, as an alternative to the model T of FIG. 5B may approximate the probability of winning with a successful bid as a function of the bid price more accurately.

Because the bidding strategy implemented by the bidding algorithm 120 may provide a trade-off between optimizing the revenue and investigating the current conditions in the marketplace 200, the state machine 600 may offer a relatively simple approach to the bidding process that may be less likely to cause a catastrophic error. That is, in one embodiment, the bidding strategy may be robust and adaptive to changes in one or more market conditions of the marketplace 200. The bidding strategy may provide a relatively simple robust, adaptive strategy for network operators or service providers to bid in a single-shot closed auction for resource requests in competitive markets which may be probable in nature, for example, spectrum trading or per-session transport bidding. Such bidding strategy to a network operator or a service provider may generate significant revenue without making many assumptions regarding a market behavior.

Portions of the present invention and corresponding detailed description are presented above in terms of software, or algorithms and symbolic representations of operations on data bits within a storage device or a semiconductor memory associated with a computing device, such as a computer or controller. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computing system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for bidding a price in an auction for at least one of goods and services within a marketplace, the method comprising:
defining a probability of winning as a function of a bid price in response to a request for wireless access in a user communication;
formulating said bidding strategy in said auction based on one of at least two forms of said probability of winning;
identifying a form for said probability of winning; and
determining one or more parameter values for said probability of winning based on the identified form to obtain a profit gain in said auction.

2. A method, as set forth in claim 1, wherein identifying a form for said probability of winning further comprising:
identifying a currently prevalent form for said probability of winning among said at least two forms in a closed-bid type of auction based on a set of mixed bidding strategies.

3. A method, as set forth in claim 1, further comprising:
adaptively developing said bidding strategy to maximize the profit gain in a closed-bid type of auction.

4. A method, as set forth in claim 1, further comprising:
providing said bidding strategy to a network operator in response to said bid price for said at least one of goods and services to a service provider in a single-shot of a closed-bid type of auction for a resource request in said marketplace.

5. A method, as set forth in claim 1, further comprising:
assuming said probability of winning with a successful bid is based on a semi-static function of said bid price.

6. A method, as set forth in claim 5, further comprising:
using a step function form to model the semi-static function of said successful bid.

7. A method, as set forth in claim 6, further comprising:
determining whether a seller assumes that said step function form describes a current situation in said marketplace;
increasing said bid price from a first bid to a second bid; and
detecting if said seller lost said first bid, and if so, assuming that a threshold has been exceeded; and
in response to exceeding said threshold, reducing said bid price by at least one increment of price.

8. A method, as set forth in claim 5, further comprising:
using a quasi-linear function form with at least two line segments and a third linear segment between said at least two line segments to model the semi-static function of said successful bid.

9. A method, as set forth in claim 8, further comprising:
determining whether a seller assumes that said quasi-linear function form describes a current situation; and
if so, using a mixed bidding strategy where said bid price varies, even if one or more conditions in said marketplace remain identical to maximize a profit and determine a shape of a curve of quasi-linear function form.

10. A method, as set forth in claim 5, further comprising:
using a state machine with at least two states for said bidding strategy so that a seller or a buyer bidding said bid price is capable of switching between use of a step function form to model the semi-static function of said successful bid and use of a quasi-linear function form with at least two line segments and a third linear segment between said at least two line segments to model the semi-static function of said successful bid.

11. A method, as set forth in claim 10, further comprising:
using said quasi-linear function form with at least two line segments and a third linear segment between said at least two line segments to characterize said probability of winning with a successful bid as a function of said bid price.

12. A method, as set forth in claim 10, further comprising:
using a mixed bidding strategy with at least two bid prices to determine said one or more parameter values for modeling the semi-static function of said successful bid based on said quasi-linear function form.

13. A method, as set forth in claim 10, further comprising:
using a mixed bidding strategy that selectively changes said bid price to check whether or not a threshold shifted when modeling the semi-static function of said successful bid based on said step function form.

14. A method, as set forth in claim 10, further comprising:
using into said state machine a combination of a first model that uses said step function form to model the semi-static function of said successful bid and a second model that uses said quasi-linear function form with at least two line segments and a third linear segment between said at least two line segments to model the semi-static function of said successful bid.

15. A method, as set forth in claim 14, further comprising:
using a non-linear model as an alternative to said second model to approximate said probability of winning with a successful bid as a function of said bid price.

16. A method, as set forth in claim 10, further comprising:
formulating said bidding strategy with no variation in said bid price or a mixed bidding strategy between updates.

17. A method, as set forth in claim 16, further comprising:
selectively changing a rate at which said updates may occur.

18. A method, as set forth in claim 17, wherein selectively changing a rate at which said updates may occur further comprising:
changing an update rate based on a change, in at least one of a market condition or environment of said marketplace and a technical condition or environment of said marketplace, of which a bidder has knowledge.

19. An operator associated with a wireless communication access network to bid for at least one of goods and services in a marketplace, said operator comprising:
a controller; and
a storage coupled to said controller, said storage storing instructions for bidding a price in an auction for at least one of goods and services within a marketplace to define a probability of winning as a function of a bid price in response to a request for wireless access in a user communication, formulate said bidding strategy in said auction based on one of at least two forms of said probability of winning, identify a form for said probability of winning, and determine one or more parameter values for said probability of winning based on the identified form to obtain a profit gain in said auction.

20. An operator, as set forth in claim 19, wherein said operator is associated with a base station that communicates with a mobile wireless device to at least one of buy and sell said at least one of goods and services to a user on a cellular network.

21. An operator, as set forth in claim 19, wherein said operator is associated with a wireless local area network that communicates with a processor-based wireless-communication enabled device to at least one of buy and sell said at least one of goods and services to a user on a local area network.

22. An operator, as set forth in claim 19, wherein said controller is coupled to a radio access network and uses a network provider agent to communicate with a broker agent over a network to broker a service contract between a user and said operator based on said bid price using an auction agent and a database of user information for a user agent at a mobile wireless device.

23. An operator, as set forth in claim 19, wherein said operator being defined at least in part by a Universal Mobile Telecommunication System (UMTS) protocol.

24. A communications system comprising:
an operator associated with a wireless communication access network to bid for at least one of goods and services in a marketplace, said operator including:
a controller; and
a storage coupled to said controller, said storage storing instructions for bidding a price in an auction for at least one of goods and services within a marketplace to define a probability of winning as a function of a bid price in response to a request for wireless access in a user communication, formulate said bidding strategy in said auction based on one of at least two forms of said probability of winning, identify a form for said probability of winning, and determine one or more parameter values for said probability of winning based on the identified form to obtain a profit gain in said auction.

25. A communications system, as set forth in claim 24, further comprising:
one or more radio access networks coupled to one or more core networks; and
a service provider coupled to said one or more core network to provide an access to said service provider on at least one of a cellular network and a wireless local area network over a network for brokering a service contract between a user of a mobile wireless device and said operator in response to said bid price for said at least one of goods and services in a single-shot of a closed-bid type of auction for a resource request in said marketplace from said user.

26. A communications system, as set forth in claim 25, wherein said mobile wireless device, said operator, said service provider, said cellular network and said wireless local area network of said wireless communication access network are being defined at least in part by a Universal Mobile Telecommunication System (UMTS) protocol.

27. An article comprising a computer readable storage medium storing instructions that, when executed cause a communications system to bid a price in an auction for at least one of goods and services within a marketplace, said communications system to:
define a probability of winning as a function of a bid price in response to a request for wireless access in a user communication;
formulate said bidding strategy in said auction based on one of at least two forms of said probability of winning;
identify a form for said probability of winning; and
determine one or more parameter values for said probability of winning based on the identified form to obtain a profit gain in said auction.

28. An apparatus for bidding a price in an auction for at least one of goods and services within a marketplace, the apparatus comprising:
means for defining a probability of winning as a function of a bid price in response to a request for wireless access in a user communication;
means for formulating said bidding strategy in said auction based on one of at least two forms of said probability of winning;
means for identifying a form for said probability of winning; and
means for determining one or more parameter values for said probability of winning based on the identified form to obtain a profit gain in said auction.
